(19) United States
(12) Patent Application Publication
(10) Pub. No.: US 2023/0056790 A1
(43) Pub. Date: Feb. 23, 2023

(54) UNIQUE IDENTIFIERS FOR DIGITAL ADVERTISEMENT, BRANDED AND INFLUENCER CONTENT

(71) Applicant: Flyshot, Inc., Toronto (CA)

(72) Inventors: Ronen Verdi, Toronto (CA); Tanya Sardana, Toronto (CA)

(73) Assignee: Flyshot, Inc., Toronto (CA)

(21) Appl. No.: 17/891,266

(22) Filed: Aug. 19, 2022

Related U.S. Application Data
(60) Provisional application No. 63/234,898, filed on Aug. 19, 2021.

(51) Int. Cl. G06Q 30/02

(52) U.S. Cl. CPC G06Q 30/0276; G06Q 30/0277

(57) ABSTRACT

A campaign management unit including an indicator generation unit that generates an indicator containing information related to a campaign and embeds the indicator in an image, an image uploading unit that receives images from users, and an indicator extraction unit that extracts an identifier from the indicator and returns an offer to the transmitting device based on the identifier.

### BACKGROUND OF THE INVENTION

Advertising on mobile communication devices has grown in recent years. With this growth, concerns over privacy have also grown resulting in technology companies restricting access to user information. These restrictions have created large hurdles for advertisers to deliver content to users. Historical methods of delivering online content to users are not effective and, in many cases, are restricted.

While numerous hurdles to delivering content exist, mobile device advertising remains a very popular method of advertising. Therefore, a need exists for a system that will allow advertisers to deliver content to a user without violating mobile platform privacy restrictions.

### SUMMARY OF THE INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present invention discloses a campaign management unit that may include an indicator generation unit that generates an indicator containing information related to a campaign and embeds the indicator in an image, an image uploading unit that receives images from users, and an indicator extraction unit that extracts an identifier from the indicator and returns an offer to the transmitting device based on the identifier.

In another embodiment, a data gathering unit separates at least one piece of data from the image into segments based on the configuration of the data in the indicator.

In another embodiment, the identification data may include, but is not limited to, the application where the content was captured, the action to be executed by the user, the offer made to the user and any other identification information.

In another embodiment, an identifier in the identification data is extracted and associated with a unique hash created for a user in a campaign management unit. In another embodiment, the data gathering unit retrieves at least one prior image transmitted from the user and determines if the uploaded image has been previously uploaded.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of a campaign management system consistent with the present invention;

FIG. 2 depicts one embodiment of a campaign management unit;

FIG. 3 depicts one embodiment of a communication device consistent with the present invention;

FIG. 4A depicts a communication device displaying a message that is part of a campaign;

FIG. 4B depicts a schematic representation of the communication between a communication device and the campaign management unit;

FIG. 5 depicts a schematic representation of the process of managing a campaign;

FIG. 6 depicts a schematic representation of a process used to create a campaign;

FIG. 7 depicts a schematic representation of a process of presenting content to a user;

FIG. 8 depicts a schematic representation of a process of extracting information from an indicator; and

FIG. 9 depicts a schematic representation of a process of presenting a campaign to a user on a communication device.

### DETAILED DESCRIPTION OF THE INVENTION

Referring now to the drawings which depict different embodiments consistent with the present invention, wherever possible, the same reference numbers will be used throughout the drawings and the following description to refer to the same or like parts.

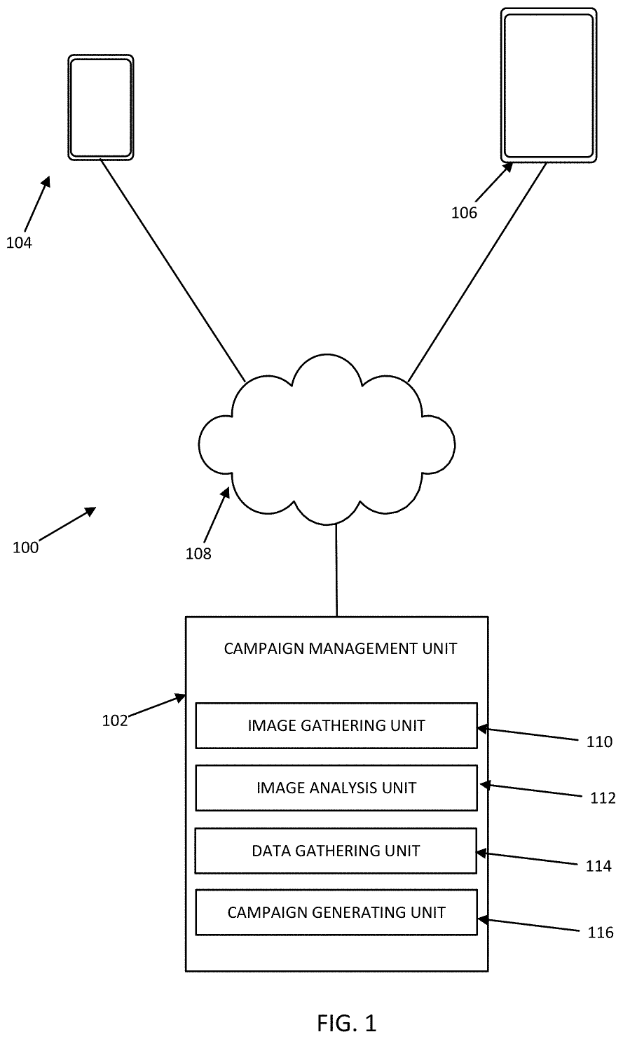

FIG. 1 depicts one embodiment of a campaign management system 100 consistent with the present invention. The campaign management system 100 includes a campaign management unit 102, a communication device 1 104, a communication device 2 106 each communicatively connected via a network 108. The campaign management unit 102 further includes an image gathering unit 110, an image analysis unit 112, a data gathering unit 114 and a campaign generating unit 116.

The image gathering unit 110 and image analysis unit 112 may be embodied by one or more servers. Alternatively, each of the data gathering unit 114 and campaign generating unit 116 may be implemented using any combination of hardware and software, whether as incorporated in a single device or as a functionally distributed across multiple platforms and devices.

In one embodiment, the network 108 is a cellular network, a TCP/IP network, or any other suitable network topology. In another embodiment, the row identification device may be servers, workstations, network appliances or any other suitable data storage devices. In another embodiment, the communication devices 104 and 106 may be any combination of cellular phones, telephones, personal data assistants, or any other suitable communication devices. In one embodiment, the network 102 may be any private or public communication network known to one skilled in the art such as a local area network (“LAN”), wide area network (“WAN”), peer-to-peer network, cellular network or any suitable network, using standard communication protocols. The network 108 may include hardwired as well as wireless branches. The image gathering unit 110 may include a digital camera.

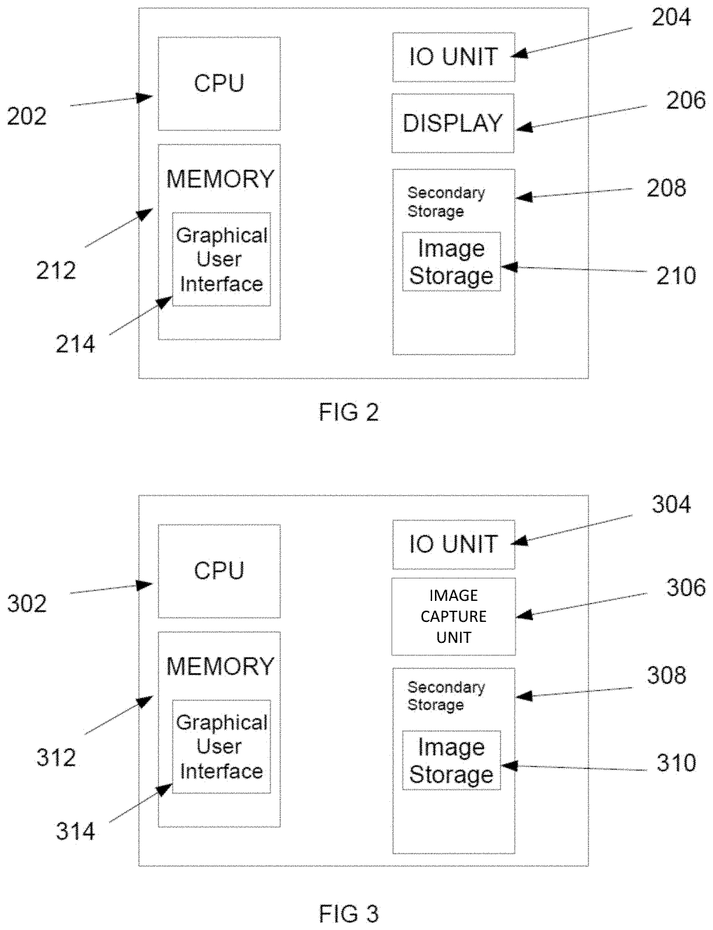

FIG. 2 depicts one embodiment of a campaign management unit 102. The campaign management unit 102 includes a network I/O device 204, a processor 202, a display 206 and a secondary storage 208 running image storage unit 210 and a memory 212 running a graphical user interface 214. The image gathering unit 110, operating in memory 208 of the campaign management unit 102, is operatively configured to receive an image from the network I/O device 204. In one embodiment, the processor 202 may be a central processing unit (“CPU”), an application specific integrated circuit (“ASIC”), a microprocessor or any other suitable processing device. The memory 212 may include a hard disk, random access memory, cache, removable media drive, mass storage or configuration suitable as storage for data, instructions, and information. In one embodiment, the memory 208 and processor 202 may be integrated. The memory may use any type of volatile or non-volatile storage techniques and mediums. The network I/O line 204 device may be a network interface card, a cellular interface card, a plain old telephone service (“POTS”) interface card, an ASCII interface card, or any other suitable network interface device. The data gathering unit 114 may be a compiled program running on a server, a process running on a microprocessor or any other suitable port control software.

FIG. 3 depicts one embodiment of a communication device 104/106 consistent with the present invention. The communication device 104/106 includes a processor 302, a network I/O Unit 304, an image capture unit 306, a secondary storage unit 308 including an image storage device 310, and memory 312 running a graphical user interface 314. In one embodiment, the processor 302 may be a central processing unit (“CPU”), an application specific integrated circuit (“ASIC”), a microprocessor or any other suitable processing device. The memory 312 may include a hard disk, random access memory, cache, removable media drive, mass storage or configuration suitable as storage for data, instructions, and information. In one embodiment, the memory 312 and processor 302 may be integrated. The memory may use any type of volatile or non-volatile storage techniques and mediums. The network I/O device 304 may be a network interface card, a plain old telephone service (“POTS”) interface card, an ASCII interface card, or any other suitable network interface device.

In one embodiment, the network 108 may be any private or public communication network known to one skilled in the art such as a Local Area Network (“LAN”), Wide Area Network (“WAN”), Peer-to-Peer Network, Cellular network or any suitable network, using standard communication protocols. The network 108 may include hardwired as well as wireless branches.

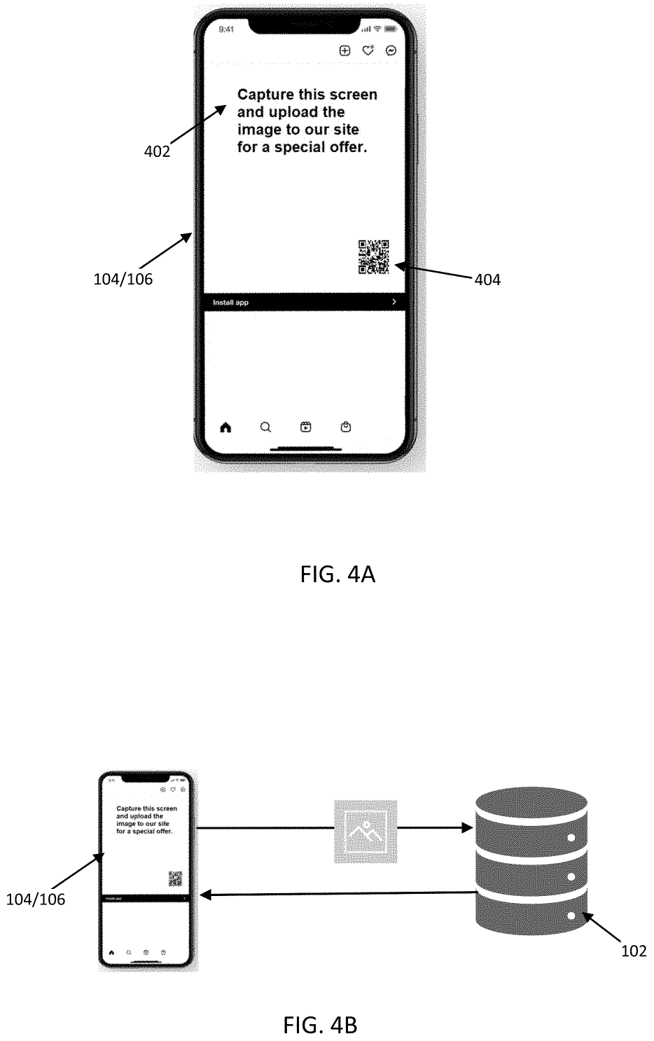

FIG. 4A depicts a communication device 104/106 displaying a message that is part of a campaign. The communication device 104/106 includes a requesting portion 402 that includes an indicator 404 in the requesting portion. The requesting portion 402 can be an image, text, video or any combination of them. FIG. 4B depicts a schematic representation of the communication between a communication device 104/106 and the campaign management unit 102. A user captures a picture of the requesting portion on the communication device 104/106 and uploads the captured image to the campaign management unit 102. Alternatively, a user's photo library may be scanned by the data gathering unit 114 to locate images taken within a predetermined number of days, a user may also point the camera to a QR code and automatically be redirected to an application with a deep-link resulting in a promotion being automatically applied. The campaign management unit 102 analyzes the image and transmits instructions back to the communication device 104/106.

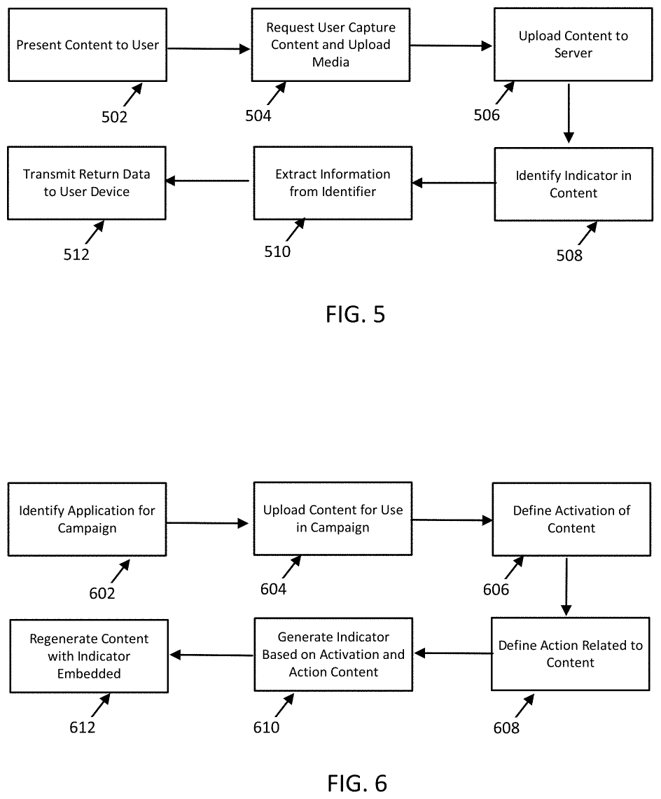

FIG. 5 depicts a schematic representation of the process of managing a campaign. In step 502, content is presented to a user on a communication device 104/106. The content may be an image, a video, text or a combination of text, video, and images. In step 504, a request to capture an image of the content is presented to the user. The user may capture an image of the content using known methods including, but not limited to, taking a screen capture of the content, taking a picture of the content with an image capture device such as a camera, point the camera to a QR code and being automatically redirected to an application with a deep-link resulting in a promotion being automatically applied or a user's photo library may be scanned by the data gathering unit 114 to locate images taken within a predetermined number of days. In step 506, the image capture of the content is uploaded to the campaign management unit 102. The image gathering unit 110 receives the uploaded image and stores the image in memory 212. In step 508, the image analysis unit 112 locates an identifier in the image. The identifier may be any identifier including, but not limited to, a QR code, a bar code, an image recognition algorithm, perceptual hashing algorithm, ML powered image classification recognition algorithm, Non-Fungible Token or NFT. In one embodiment, the identifier is an image embedded into a predetermined location in the content. Consistent with this embodiment, the image analysis unit 112 scans the content to locate the identifier in the content. In another embodiment, the identifier is a pattern embedded in an image. Consistent with this embodiment, the image analysis unit 112 scans the image to locate the identifier pattern. The identifier may include a plurality of information in an identifier.

In step 510, data gathering unit 114 extracts information from the identifier. The identifier may include information on the campaign including, but not limited to, an identifier, the application or website displaying the campaign, the expiration date of the campaign, an offer associated with the campaign, or any other information related to the campaign. In one embodiment, the identifier is a UUID Primary Key in a database pointing to other variables, which is extracted from the indicator. In step 512, the campaign generating unit 116 transmits an action request to the communication device 104/106. The action request may be any request for the user to perform a task including, but not limited to, requesting the user purchase an item at a discount, redirecting the user to an external website, or any other action.

FIG. 6 depicts a schematic representation of a process used to create a campaign. In step 602, the campaign generation unit 116 identifies an application that will present the campaign to a user via a communication device 104/106. The application may be any application including, but not limited to, a mobile application, a website, a tablet application, or any other type of application. In step 604, the campaign generation unit 116 receives content to include in the campaign. The content may be any content including images, videos, and/or text. In step 606, the campaign management unit 116 defines the activation conditions for the campaign. The activation conditions may include, but are not limited to, the start date and expiration date of the campaign, the application or website displaying the content or any other campaign information. In step 608, the campaign generation unit 116 defines an action to be performed by a user viewing the content. The action may include, but is not limited to, a request for a user to purchase an item, view a website, install an application or any other action a user can perform on a computer or communication device 104/106. In step 610, the campaign generating unit 116 generates an indicator based on the activation and action content. In step 612, the campaign generation unit 116 generates new content incorporating the indicator.

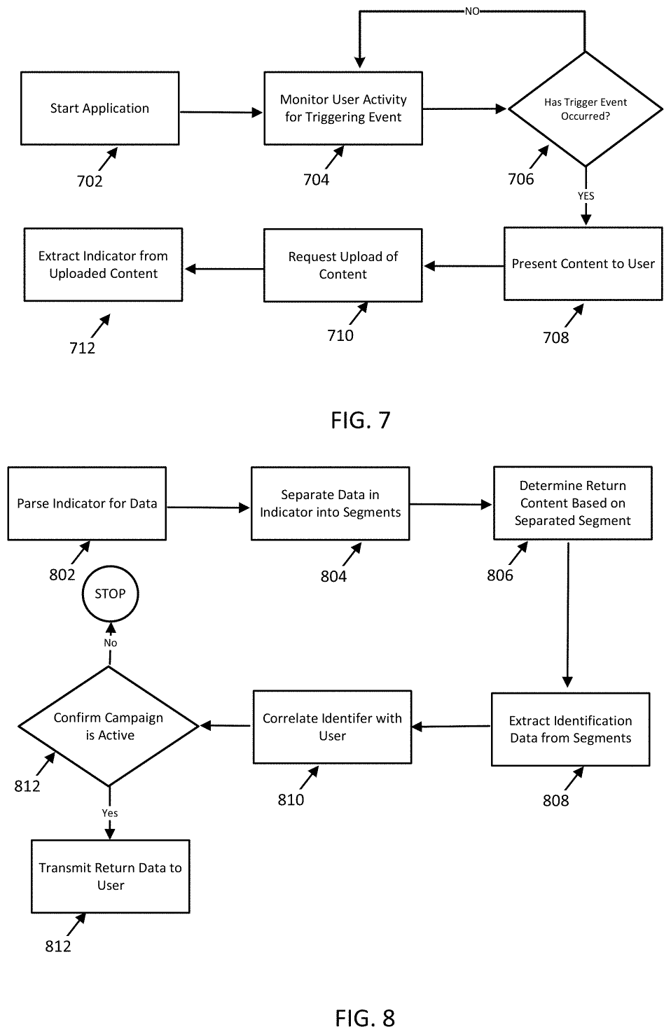

FIG. 7 depicts a schematic representation of a process of presenting content to a user. In step 702, an application is started on a communication device 104/106. The application may be a compiled application or an application running on a website. In step 704, the application monitors the user activity for a triggering event associated with a campaign. The triggering event may be the selection of an item in the application, achieving a goal in a game or any other triggering event. In step 706, the application determines if the trigger event has occurred. If the trigger event has occurred, the application presents the content to the user in step 708. If the trigger event has not occurred, the application continues to monitor for the trigger event. In step 710, the application requests the user capture the image of the content and upload the content to the campaign management unit 102. Uploading content may include, but is not limited to, scanning a photo library, capturing a QR code by positioning a camera in front of the QR and capturing the image offline, and being redirected inside an application with deep-link and promotion applied automatically. In step 712, the campaign management unit 102 receives the captured images and extracts the indicator, which includes the identifier, from the captured image.

FIG. 8 depicts a schematic representation of a process of extracting information from an indicator. In step 802, the data gathering unit 114 parses the indicator for data including the identifier. In step 804, the data gathering unit 114 separates the data into segments based on the configuration of the data in the indicator. In step 806, the campaign generation unit 116 analyzes the data to determine the segmented content to be returned to the communication device 104/106. In step 808, identification data is extracted from the data segments. The identification data may include, but is not limited to, the application where the content was captured, the action to be executed by the user, the offer made to the user and any other identification information. In step 810, an identifier in the identification data is extracted and associated with a unique hash created for the user in the campaign management unit 102. In one embodiment, the data gathering unit 114 retrieves prior content transmitted from the user and determines if the uploaded content has been previously uploaded. In step 812, the campaign generation unit 116 creates return data and transmits the return data to the communication device 104/106.

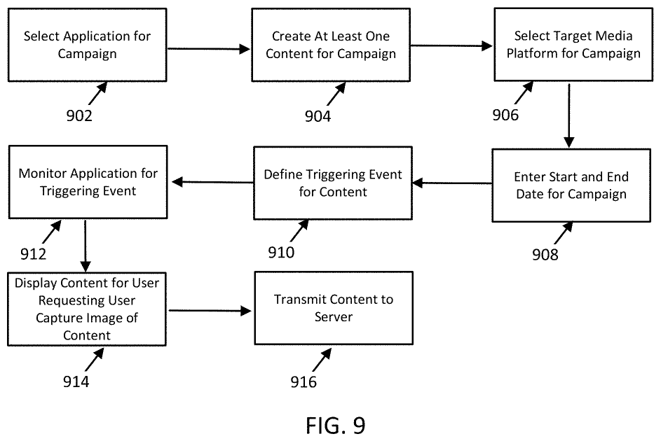

FIG. 9 depicts a schematic representation of a process of presenting a campaign to a user on a communication device 104/106. In step 902, the campaign generation unit 116 selects an application to present the campaign. In step 904, the campaign generation unit 102 correlates at least one piece of content with the application. In step 906, the campaign generation unit 116 selects the target media platform for the campaign. In step 908, the campaign generation unit 116 gathers the start and end date for the campaign. In step 910, a triggering event that causes the content to be displayed to the user is identified in the application. In step 912, the application monitors the activity on the application for the triggering event. In step 914, the content for the campaign is displayed to the user on the communication device 104/106. In step 916, the user transmits a capture of the content to the campaign generation unit 102.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed:

1. A campaign management unit including:
an indicator generation unit that generates an indicator containing information related to a campaign and embeds the indicator in an image;
an image uploading unit that receives images from users; and
an indicator extraction unit that extracts an identifier from the indicator and returns an offer to the transmitting device based on the identifier.

2. The campaign management unit of claim 1, wherein a data gathering unit separates at least one piece of data from the image into segments based on the configuration of the data in the indicator.

3. The campaign management unit of claim 2, wherein the identification data may include, but is not limited to, the application where the content was captured, the action to be executed by the user, the offer made to the user and any other identification information.

4. The campaign management unit of claim 3, wherein an identifier in the identification data is extracted and associated with a unique hash created for a user in a campaign management unit.

5. The campaign management unit of claim 4 wherein, the data gathering unit retrieves at least one prior image transmitted from the user and determines if the uploaded image has been previously uploaded.
